(19) United States
(12) Patent Application Publication
(10) Pub. No.: US 2005/0203851 A1
(43) Pub. Date: Sep. 15, 2005

(54) Corruption and its deterrence in swarm downloads of protected files in a file sharing network

(75) Inventors: Neil King, London (GB); James Moore, Colchester (GB); Michael Wayne Colburn, Redwood City, CA (US); Jeremy Elliott, Berkeley, CA (US)

Correspondence Address: PATENT DEPARTMENT;MACROVISION CORPORATION, 2830 DE LA CRUZ BLVD., SANTA CLARA, CA, 95050, US

(73) Assignee: Macrovision Corporation

(21) Appl. No.: 11/052,171

(22) Filed: Feb. 7, 2005

Related U.S. Application Data
(63) Continuation-in-part of application No. 10/803,784, filed on Mar. 18, 2004.
(60) Provisional application No. 60/514,429, filed on Oct. 25, 2003.
(60) Provisional application No. 60/514,430, filed on Oct. 25, 2003.
(60) Provisional application No. 60/518,691, filed on Nov. 10, 2003.
(60) Provisional application No. 60/528,466, filed on Dec. 10, 2003.

(30) Foreign Application Priority Data
Sep. 10, 2004 (WO) PCT/US04/29869

(51) Int. Cl. G06F 17/60

(52) U.S. Cl. 705/51

(57) ABSTRACT

A method and apparatus for corrupting a swarm download in a file sharing network provides corrupt data in response to a request for a portion of a file so that when portions received from various sources are assembled, the assembled product cannot be verified and the process must be repeated. To defeat the method, bad sources are identified and disconnected or otherwise ignored, or good sources are identified and given higher priorities. In another method for deterring unauthorized copying of a protected file in a P2P network, a P2P client offering the protected file is choked with agents connecting to it so that its upload capacity is diluted. In another method, false sources for a protected file are injected into a file sharing network so as to dilute the legitimate sources, making them more difficult to find.

### CROSS REFERENCE TO RELATED APPLICATIONS

This application is a continuation-in-part to U.S. application Ser. No. 10/803,784 filed Mar. 18, 2004, which claims priority to U.S. Provisional Application Ser. No. 60/514,429 filed Oct. 25, 2003, U.S. Provisional Application Ser. No. 60/514,430 filed Oct. 25, 2003, U.S. Provisional Application Ser. No. 60/518,691 filed Nov. 10, 2003, and U.S. Provisional Application Ser. No. 60/528,466 filed Dec. 10, 2003, all of which are incorporated by reference to the extent consistent herein.

### FIELD OF THE INVENTION

The present invention generally relates to techniques for deterring unauthorized copying in file sharing networks and in particular, to methods and apparatuses for corruption and its deterrence in swarm and other downloads of protected files in a file sharing network.

### BACKGROUND OF THE INVENTION

Unauthorized copying in decentralized networks using peer-to-peer (P2P) file sharing has become a major concern to owners of copyrighted material. Unlike a centralized network, decentralization makes it commercially impractical to pursue all copyright violators in court. This is because decentralization requires filing lawsuits against virtually millions of client computer operators instead of only one party operating a central computer.

Accordingly, copyright owners seek other methods for protecting their copyrighted material, such as blocking, diverting or otherwise impairing the unauthorized distribution of their copyrighted works on a publicly accessible decentralized or P2P file trading network. In order to preserve the legitimate expectations and rights of users of such a network, however, it is desirable that copyright owners do not alter, delete, or otherwise impair the integrity of any computer file or data lawfully residing on the computer of a file trader.

Swarm downloads are particularly efficient for sharing files in a file sharing network. To perform a swarm download, a file to be shared is divided into parts that can be concurrently requested and downloaded from different sources (i.e., other client nodes) in the file sharing network. Downloaded parts may then in turn, be made available to other client nodes so as to increase the number of sources for the part and consequently, speed up overall downloading of the file within the network by all client nodes that are procuring a copy of the file.

In one form of swarm download, the file is divided into segments. Different segments are then requested from different sources that have indicated not only availability of the file, but also an identical hash value for their available file. After all of segments have been downloaded from various sources, a hash value is calculated for the assembled file and compared to the known hash value. If they match, then the download was successful. On the other hand, if they do not match, then the downloaded file is determined to be corrupted, and the segments of the file are downloaded again from the same or different sources.

In another form of swarm download, the file is divided into pieces, and the pieces further divided into blocks. In this case, hash values are calculated for each of the pieces. Different blocks are then requested from different sources that have indicated not only availability of their corresponding pieces, but also an identical hash value for the piece. After all of blocks have been downloaded from various sources for a piece, a hash value is calculated for the assembled piece and compared to the known hash value for that piece. If they match, then the download was successful. On the other hand, if they do not match, then the downloaded piece is determined to be corrupted, and the blocks of the piece are downloaded again from the same or different sources.

### OBJECTS AND SUMMARY OF THE INVENTION

Although swarm downloads are useful for many legitimate file sharing activities, they can also be used unfortunately for unauthorized copying of protected files (i.e., files that are to be protected against unauthorized copying).

Accordingly, it is an object of one or more aspects of the present invention to provide a method and apparatus for corrupting a swarm download of a protected file in a file sharing network.

Another object is to provide such method and apparatus so that the legitimate rights and expectations of users of the network are preserved.

Still another object is to provide such method and apparatus such that the network is not prevented from operating for legitimate file sharing activities.

Yet another object is to provide such method and apparatus so that copies of files already residing on the network are not destroyed through erasure or corruption of data.

Conversely, it is another object of one or more aspects of the present invention to provide a method for deterring corruption of a swarm download in a file sharing network when it is desirable to do so.

These and additional objects are accomplished by the various aspects of the present invention, wherein briefly stated, one aspect is a method for corrupting a swarm download in a file sharing network, comprising: receiving a request from a client in a file sharing network for a portion of a file as part of a swarm download, and providing different content rather than the requested portion so that a calculation based in part on the different content indicates that the swarm download has been corrupted.

Another aspect is a method for corrupting a swarm download in a network, comprising: connecting to a client participating in a swarm download of a file; indicating to the client that pieces of the file not including any blocks for which corrupting data was previously provided to the client are available for downloading; receiving a request for a block of a piece identified as being available; sending a block of corrupting content to the client in response to the request so that a calculation based in part on the corrupting content indicates that an assembled piece has been corrupted; and disconnecting from the client.

Another aspect is an apparatus for corrupting a swarm download in a file sharing network, comprising an agent client configured to receive a request from a requesting client for a portion of a file as part of a swarm download in a file sharing network, and provide different content rather than the requested portion so that a calculation based in part on the different content indicates that the swarm download has been corrupted.

Another aspect is an apparatus for corrupting a swarm download in a network, comprising an agent client configured to: connect to a requesting client participating in a swarm download of a file; indicate to the requesting client that pieces of the file not including any blocks for which corrupting content was previously provided to the client are available for downloading; receive a request for a block of a piece identified as being available; send a block of corrupting content to the requesting client in response to the request so that a calculation based in part on the corrupting content indicates that an assembled piece has been corrupted; and disconnect from the requesting client.

Another aspect is a method for deterring corruption of a swarm download in a file sharing network, comprising: keeping track of reported available pieces for downloading from each connected client, and disconnecting any such client that reports less available pieces for downloading than reported by that client at a prior time.

Another aspect is a method for deterring corruption of a swarm download in a file sharing network, comprising: keeping track of a number of times a client requests connection during a swarm download, and denying such request if the number is greater than or equal to a threshold number.

Another aspect is a method for deterring corruption of a swarm download in a file sharing network, comprising: identifying bad sources in a network by analyzing source statistics updated each time a calculated hash for a piece of a file downloaded as blocks to a client from a plurality of sources fails to match a known hash value for the piece.

Another aspect is a method for deterring corruption of a swarm download in a file sharing network, comprising: identifying good sources in a network by analyzing source statistics updated each time a calculated hash for a piece of a file downloaded as blocks to a client from a plurality of sources matches a known hash value for the piece.

Another aspect is a method for deterring corruption of a swarm download in a file sharing network, comprising: requesting blocks of a piece of a file in a redundant fashion from alternative sources, assembling the piece from selected blocks, and identifying a bad source providing corrupting content in one of the selected blocks by repeatedly replacing individual of the blocks in the assembled piece with a corresponding block from one of the alternative sources until a calculated hash value for the assembled piece is verified.

Another aspect is a method for deterring unauthorized copying of a protected file in a file sharing network, comprising: identifying a client offering a piece of a protected file for downloading in a file sharing network, and repeatedly connecting an agent to the client using a different IP address from a range of IP addresses pre-assigned to the agent for each connection, so as to reduce a number of available connections for other clients in the file sharing network to download blocks of the piece from the client.

Yet another aspect is a method for deterring unauthorized copying of a protected file in a file sharing network, comprising: repeatedly connecting an agent to a server by using a different IP address from a range of IP addresses pre-assigned to the agent for each connection and falsely notifying the server that the agent has the protected file available for downloading each time, so as to increase the difficulty for client nodes to locate legitimate sources for the protected file.

Additional objects, features and advantages of the various aspects of the present invention will become apparent from the following description of its preferred embodiment, which description should be taken in conjunction with the accompanying drawings.

### BRIEF DESCRIPTION OF THE DRAWINGS

FIG. 1 illustrates a block diagram of a BitTorrent network including at least one client computer configured to utilize aspects of the present invention.

FIG. 2 illustrates a flow diagram a method for corrupting a swarm download in a file sharing network, utilizing aspects of the present invention.

FIG. 3 illustrates a flow diagram of a reported number of pieces tracking method for deterring corruption of a swarm download in a file sharing network, utilizing aspects of the present invention.

FIG. 4 illustrates a flow diagram of a number of requested connections tracking method for deterring corruption of a swarm download in a file sharing network, utilizing aspects of the present invention.

FIG. 5 illustrates a flow diagram of a bad source identifying method for deterring corruption of a swarm download in a file sharing network, utilizing aspects of the present invention.

FIG. 6 illustrates a flow diagram of a good source identifying method for deterring corruption of a swarm download in a file sharing network, utilizing aspects of the present invention.

FIGS. 7-8 illustrate flow diagrams for an alternative bad source identifying method for deterring corruption of a swarm download in a file sharing network, utilizing aspects of the present invention.

FIGS. 9-10 illustrate flow diagrams for an alternative good source identifying method for deterring corruption of a swarm download in a file sharing network, utilizing aspects of the present invention.

FIG. 11 illustrates a flow diagram of a redundant block requesting method for deterring corruption of a swarm download in a file sharing network, utilizing aspects of the present invention.

FIG. 12 illustrates a flow diagram an upload choking method for deterring unauthorized copying in a file sharing network, utilizing aspects of the present invention.

FIG. 13 illustrates a flow diagram of a source injection method for deterring unauthorized copying in a file sharing network, utilizing aspects of the present invention.

### DETAILED DESCRIPTION OF THE PREFERRED EMBODIMENT

Both decentralized networks such as those using the Gnutella or eDonkey protocols, and decentralized tracker-based networks such as those using the BitTorrent protocol facilitate swarm downloading of files. Although the methods described herein for corrupting or deterring the corruption of a swarm download are generally applicable to all such networks supporting swarm downloads, the BitTorrent network is used in the following description for illustrative and preferred embodiment purposes.

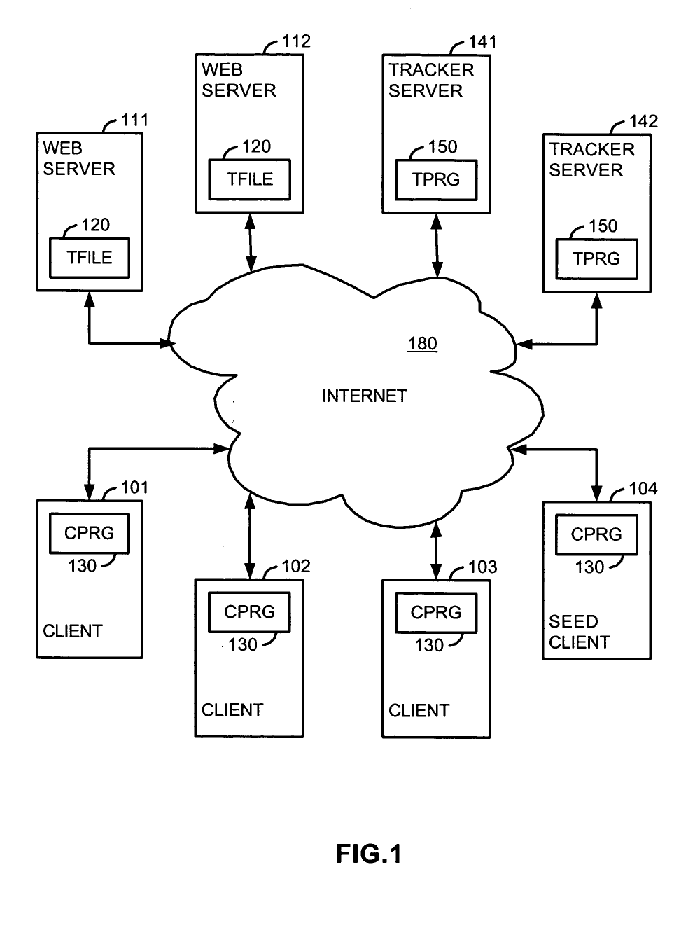

Referring to FIG. 1, web servers, such as servers 111 and 112, serve as depositories of a metainfo (.torrent) file (TFILE) 120 which is associated with a particular content file such as an MP3 audio file of a particular song performed by a particular artist, so that the Torrent file 120 is available for downloading over the Internet 180 by client nodes, such as clients 101-104. In this case, users of the clients 101-104 may already know the web addresses of one or more of the servers 111 and 112 so that they can contact them directly to download the Torrent file 120, or they may be linked to the Torrent file 120 through a web page, or they may otherwise find the Torrent file 120 by searching for it using an Internet search engine.

Each of the clients 101-104 is configured with a client version of a BitTorrent program (CPRG) 130 which is associated with the Torrent file 120 so as to be capable of reading it and identify one or more tracker servers indicated therein by their URLs, such as tracker servers 141 and 142. The CPRG program 130 may then display the identified tracker servers to the user of its client node, and the user may then select one of the identified tracker servers for the CPRG program 130 to contact in order to procure a copy of the content file associated with the Torrent file 120. In order to properly communicate with the connecting CPRG program 130, each of the tracker servers 141 and 142 is configured with a tracker version of the BitTorrent program (TPRG) 150.

As an example, if users of clients 101 and 102 select tracker server 141, their respective CPRG programs 130 contact and communicate with the TPRG 150 of the tracker server 141. The TPRG program 150 then sends a network list back to each of the connecting clients 101 and 102. Included in the network list is contact information for at least one “seed” client such as client 104 which has a full copy of the content file that the clients 101 and 102 are seeking to procure a copy of, as well as contact information for clients such as and including clients 101 and 102 that have recently contacted the tracker server 141 regarding the content file.

The CPRG programs 130 of the clients 101 and 102 then use the information in the provided network list to establish peer-to-peer (P2P) communications with the seed client 104, and one another, in order to download the content file which is associated with the Torrent file 120, using a swarm download.

Downloading is performed in this case using the BitTorrent protocol wherein the content file is divided into pieces, and blocks of pieces are requested from other clients in the P2P network which have indicated that they have those pieces available for downloading. Initially, the seed client 104 may be the only client in the P2P network that has any of the pieces available for downloading. When a piece is successfully downloaded to one of the clients, however, the CPRG program 130 of that client announces to other clients that it is connected to in the P2P network that it now has that piece available for downloading. As more clients join the P2P network along with the clients 101 and 102, this will further serve to speed up the distribution of the content file to all P2P network clients as they participate in the swarm download. Eventually, all of the pieces of the content file may be available within the P2P network from other than the seed client 104. At that time, the seed client 104 may disconnect itself from the P2P network.

Before announcing the availability of an assembled piece from downloaded blocks, the CPRG program 130 first verifies that the assembled piece is good. It does this, for example, by calculating a hash value (such as a SHA-1 or MD4) for the assembled piece and comparing the calculated hash value against a known hash value provided, for example, in the Torrent file 120. If the two hash values match, then the piece is determined to be good. In this case, the other P2P clients are notified by the CPRG program 130 of the assembled piece's availability for downloading. On the other hand, if the two hash values do not match, then the piece is determined to be corrupted. In this case, the downloaded blocks for that piece are discarded and requested again from the same or different sources (i.e., other clients on the P2P network). As clients successfully download all pieces of the content file, they may disconnect from the P2P network. At the same time, other clients may be joining the P2P network to download the content file from remaining sources in the P2P network, so that the network may be dynamically changing with respect to its nodes. In order to be notified of such newly joining client nodes, as well as maintain its own contact information in the network list, it is useful for a client node already participating in a swarm download to periodically re-connect to the tracker server and obtain an updated network list.

Although there are many legitimate uses for a P2P network such as the BitTorrent network described in reference to FIG. 1, the network may also be used unfortunately for unauthorized copying of protected files. To deter such unauthorized copying, an agent client 103 may join the P2P network by contacting the tracker server 141 like any other client, and then contacting the other clients in the P2P network individually to perform various methods for corrupting the swarm download, or otherwise deterring unauthorized copying of the protected file in the file sharing network.

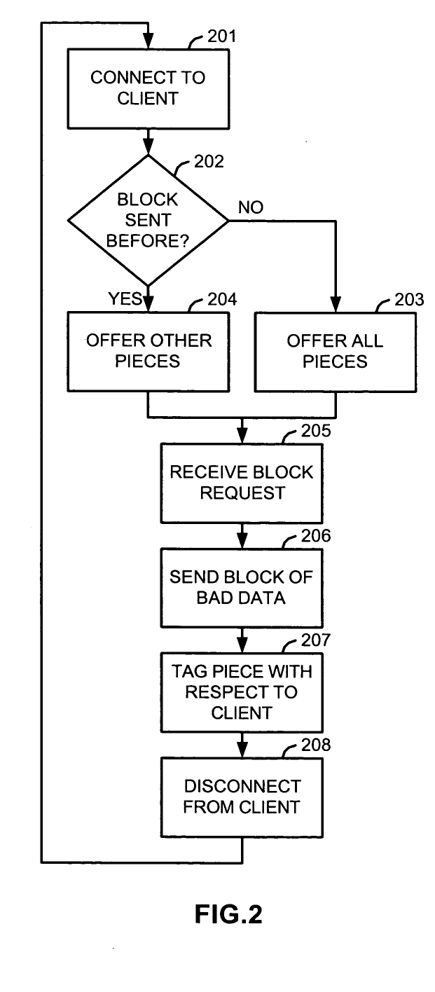

FIG. 2 illustrates, as an example, a flow diagram a method for corrupting a swarm download of a protected file in a file sharing network. The protected file in this case is a content file that an agent client node (also referred to herein as simply an “agent” or “agent client”) is configured to protect by preventing or at least deterring its unauthorized distribution within a file sharing network. The distribution in this case is referred to as being unauthorized if the owner of the protected file has not authorized the distribution. Also, the operator of the agent client node is generally a representative or authorized agent of the protected file's owner.

In 201, the agent client node (e.g., agent client 103 in FIG. 1), connects to one of the client nodes (e.g., client 101 or 102 in FIG. 1) which is participating in the swarm download of the protected file. In 202, the agent client node determines whether it has previously sent a block of the protected file to the connected client. If the determination in 202 is a NO, then in 203, the agent client node indicates to the connected client that it has all pieces of the protected file available for downloading. On the other hand, if the determination in 202 is YES, then in 204, the agent client node indicates to the connected client that it has all pieces except those associated with the previously sent blocks available for downloading.

In 205, the agent client node receives a block request from the connected client for one of the pieces that it previously indicated in 203 or 204 as being available for downloading to the connected client. In 206, the agent client node responds to the block request by sending a block of bad or corrupt data instead of the requested block of the piece of the content file. In 207, the agent client node then tags the piece corresponding to the requested block, so that the piece will not be offered as being available in a subsequent communication (e.g., in a subsequent iteration through 204) to the connected client.

In 208, the agent client node then disconnects from the connected client, and goes back to 201 to reconnect to the client and repeat 201-208 until a bad block for each of the pieces of the protected file has been sent (e.g., in a iterations through 206) to the connected client. Alternatively, rather than disconnecting in 208 and reconnecting in 201 after each bad block is sent, the agent client node may jump back to 202 to repeat 202-207 until a bad block for each of the pieces of the protected file has been sent.

As a result of each iteration through 201-208 (or alternatively through 202-207 if the agent client node does not disconnect and reconnect after sending each bad block of data), a bad block is sent to the connected client for a corresponding piece of the protected file. When the connected client assembles the corresponding piece from blocks downloaded from various sources in the P2P network, the assembled piece will fail a hash verification test and therefore, be determined as being corrupted. Since the client that requested the blocks will not know which of the downloaded blocks is bad, all of the downloaded blocks will be discarded for the assembled piece, and the client will have to request the blocks again from the same or different sources in the P2P network.

In the above described method, once a bad block for a corresponding piece is sent in 206, that piece is no longer advertised as being available to the block requesting client. One reason for this approach is to make detection of the agent client node as a corrupting source more difficult. Alternatively, however, all pieces may always be announced as being available to the block requesting client to simplify implementation of the agent client node by eliminating 202, 204 and 207 in the method.

Although described in terms of the BitTorrent protocol, the basic method described in reference to FIG. 2 may also be applied in a file segmentation scheme for conducting swarm downloads. In that case, the method is simplified so that instead of announcing availability of any pieces, the agent client node simply announces to other nodes in the P2P network that it has the protected file available for sharing. Then, when it receives a request for a segment of the file, it sends a segment of corrupted data instead.

Although there are legitimate reasons for corrupting an unauthorized swarm download of a protected file, there may also be good reasons for deterring a corruption of a swarm download, especially when the download is either authorized or the file being downloaded is a file that is freely available.

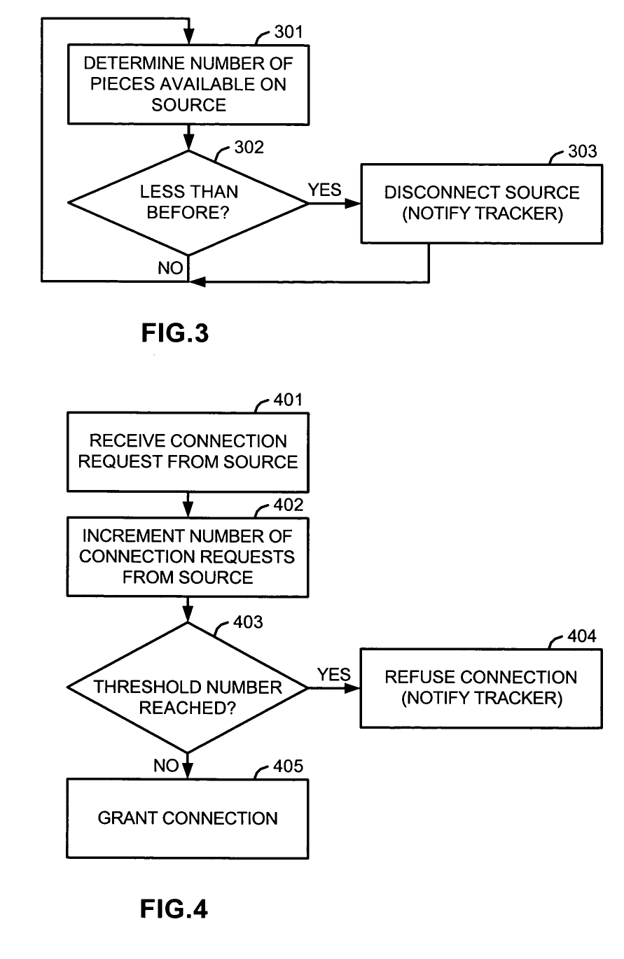

FIG. 3 illustrates, as an example, a flow diagram of a reported number of pieces tracking method for deterring corruption of a swarm download in a file sharing network. This method is effective in response to the swarm download corruption method described in reference to FIG. 2, because in that method, the agent client node reports one less piece of the file each time it sends a corrupted block of data in response to a requested block of a piece of the file. The method is performed by each of the client nodes in the P2P network (such as client nodes 101 and 102 in FIG. 1), and preferably implemented in the CPRG program 130.

In 301, a block requesting client determines the number of pieces being reported as available by each of the other client nodes in the P2P network. In 302, the block requesting client determines whether the number of pieces reported as being available by one of the other clients in the P2P network is less than it previously reported. If the determination in 302 is YES, then in 303, the block requesting client disconnects from that source (or thereafter ignores it), and optionally informs the tracker server so that it can remove the source from the network list. On the other hand, if the determination in 302 is NO, then the method jumps back to 301 and continues to keep looping through 301-303 until the block requesting client completes its downloading of the file.

FIG. 4 illustrates, as an example, a flow diagram of a number of requested connections tracking method for deterring corruption of a swarm download in a file sharing network. This method is effective in response to the swarm download corruption method described in reference to FIG. 2, because in that method, the agent client node disconnects and reconnects to the block requesting client each time it sends a corrupted block of data in response to a requested block of a piece of the file. The method is also performed by each of the client nodes in the P2P network (such as client nodes 101 and 102 in FIG. 1), and preferably implemented in the CPRG program 130.

In 401, the block requesting client receives a connection request from another client or source in the network. In 402, the block requesting client increments a counter which keeps track of the number of connection requests that it has received from that source. In 403, the block requesting client makes a determination whether the count has reached a threshold number. The threshold value in this case may be as low as two, or any other number that represents a reasonable number of disconnect and reconnects from a single source during the period of time that it takes the block requesting client to download the entire content file in a swarm download.

If the determination in 403 is YES, then in 404, the block requesting client refuses the connection with that source, and optionally, informs the tracker server so that the tracker server can remove the source from the network list provided to all clients in the P2P network communicating with that tracker server. On the other hand, if the determination in 403 is NO, then in 405, the block requesting client grants the source's the connection request.

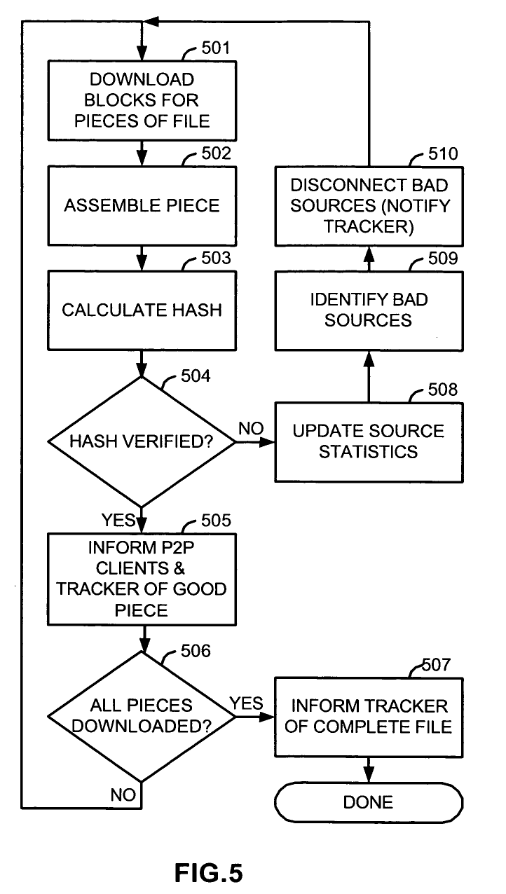

FIG. 5 illustrates, as an example, a flow diagram of a bad source identifying method for deterring corruption of a swarm download in a file sharing network. In this method, 501-507 are conventional tasks performed in the BitTorrent protocol by a block requesting client (such as client 101 or 102 in the example described in reference to FIG. 1) during a swarm download of a content file in a file sharing network.

In particular, in 501, the block requesting client downloads blocks for pieces of the file from various sources in the file sharing P2P network. In 502, when all the blocks for a piece of the file have been downloaded, the piece is assembled from the downloaded blocks, and in 503, a hash value is calculated for the assembled piece. In 504, the calculated hash value is then compared against a known hash value for the piece provided, for example, in the Torrent file, the tracker server, or other P2P clients. If the hash is verified (i.e., the hash values match), then in 505, availability of the good piece is announced to other clients in the P2P network and to the tracker server. A determination is then made in 506, whether all pieces of the file have now been downloaded. If the determination in 506 is NO, then the method jumps back to 501 to keep downloading blocks for other pieces of the file. On the other hand, if the determination in 506 is YES, then in 507, the tracker server is informed that all pieces of the file have been downloaded so that a complete file now resides on the block requesting client.

If the hash is not verified, however, so that the determination in 504 results in a NO, then the block requesting client performs additional functions in order to identify bad sources. In this case, after having failed to verify the hash of the assembled piece and therefore, determining that the piece is corrupted, in 508, the block requesting client updates source statistics that it is keeping track of for each of the sources that provided one or more blocks for the corrupted piece. In 509, the block requesting client then analyzes the source statistics to identify bad sources according to predetermined criteria, and in 510, the block requesting client disconnects from (or otherwise ignores) the identified bad sources (e.g., P2P clients that have been found to provide corrupting data more frequently than an acceptable level), and optionally, notifies the tracker server of the identified bad sources so that the tracker server may remove the sources from the network list that it provides to the other P2P clients. The method then continues looping through 501-510 until all pieces of the file have been successfully downloaded.

As an example of 508-509 of the method, if client 101 in FIG. 1 downloads all of the blocks of a corrupted piece from clients 103 and 104 (also referred to as being “sources” since the downloaded blocks are provided by these clients), then in performing the updating of source statistics in 508, it would increment a counter associated with client 103 once for each block provided by that client for the corrupted piece, and it would increment another counter associated with client 104 once for each block provided by that client for the corrupted piece. Assuming each piece consists of two blocks, then in this case, the counter associated with client 103 and the counter associated with client 104 would each be incremented once.

Continuing with the example, if the client 101 then downloads all of the blocks of another corrupted piece from clients 102 and 103, then in performing the updating of source statistics again in 508, it would increment a counter associated with client 102 once, and the counter associated with client 103 a second time. At this point, the count of the counter for client 102 is one, the count of the counter for client 103 is two, and the count of the counter for client 104 is one. If the criteria for determining bad sources is a count of two or greater for their respective counters, then in performing the identification of bad sources in 509, client 103 would be identified by the block requesting client 101 as a bad source after applying the criteria to the count of each of the counters of the clients 102, 103 and 104.

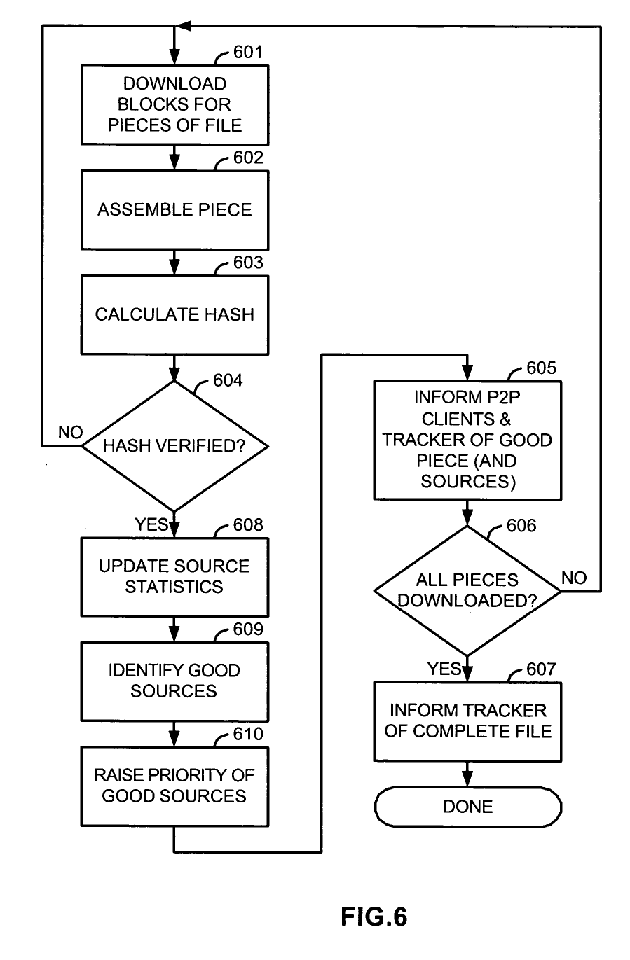

FIG. 6 illustrates, as an example, a flow diagram of a good source identifying method for deterring corruption of a swarm download in a file sharing network. In this method, 601-607 are generally conventional tasks performed in the BitTorrent protocol by a block requesting client (such as client 101 or 102 in the example described in reference to FIG. 1) during a swarm download of a content file in a file sharing network. This method primarily differs from the previously described method of FIG. 5 in that this method identifies good sources so that they may be rewarded by raising their downloading and/or uploading priorities rather than identifying bad sources so that they may be disconnected.

Accordingly, when the hash of an assembled piece is found to be corrupted in 604, the method of FIG. 6 takes no special action, and proceeds in a conventional BitTorrent fashion by discarding the downloaded blocks for the corrupted piece and continuing with 601 to download blocks for pieces of the file. On the other hand, when the hash is verified in 604, the block requesting client performs some additional tasks according to the method of FIG. 6.

In 608, the block requesting client updates source statistics that it is keeping track of for each of the sources that provided one or more blocks for the verified piece. In 609, the block requesting client then analyzes the source statistics to identify good sources according to predetermined criteria such as a minimum number of times that the source has been involved in a good piece download, and in 610, the block requesting client raises the priorities of those good sources for downloading and/or uploading purposes. As a possible added feature, in 605, when the block requesting client notifies or informs the other P2P clients and the tracker server of the availability of the verified piece for downloading, it may also optionally, notify the tracker server of the identified good sources so that the tracker server may indicate such information in the network list so that other P2P clients may also raise the priority of these sources for downloading and/or uploading purposes.

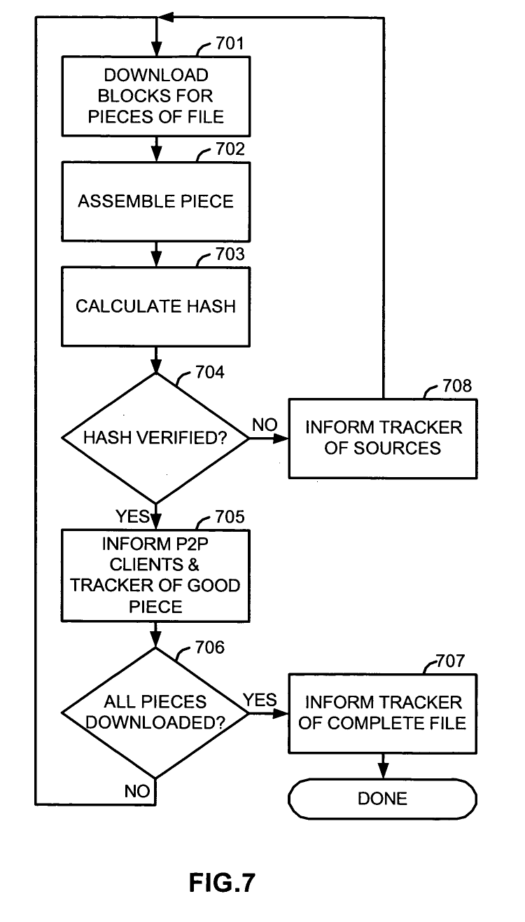

FIGS. 7˜8 illustrate, as examples, flow diagrams for an alternative bad source identifying method for deterring corruption of a swarm download in a file sharing network. This method primarily differs from the method described in reference to FIG. 5 in that instead of the block requesting client updating the source statistics and identifying bad sources, the block/source information for corrupted pieces are sent to the tracker server, and the tracker server performs those functions.

Therefore, as in the case of 501-507 in FIG. 5, 701-707 in FIG. 7 are generally conventional tasks performed in the BitTorrent protocol by a block requesting client (such as client 101 or 102 in the example described in reference to FIG. 1) during a swarm download of a content file in a file sharing network. As long as the hashes for assembled pieces from downloaded blocks are verified in 704, the method performs in the same manner as a conventional BitTorrent swarm download process. If the hash is not verified in 704, however, then in 708, the block requesting client sends source information for the blocks of the corrupted piece to the tracker server before going back to 701 to continue looping through 701-708 until all pieces of the content file have been successfully downloaded.

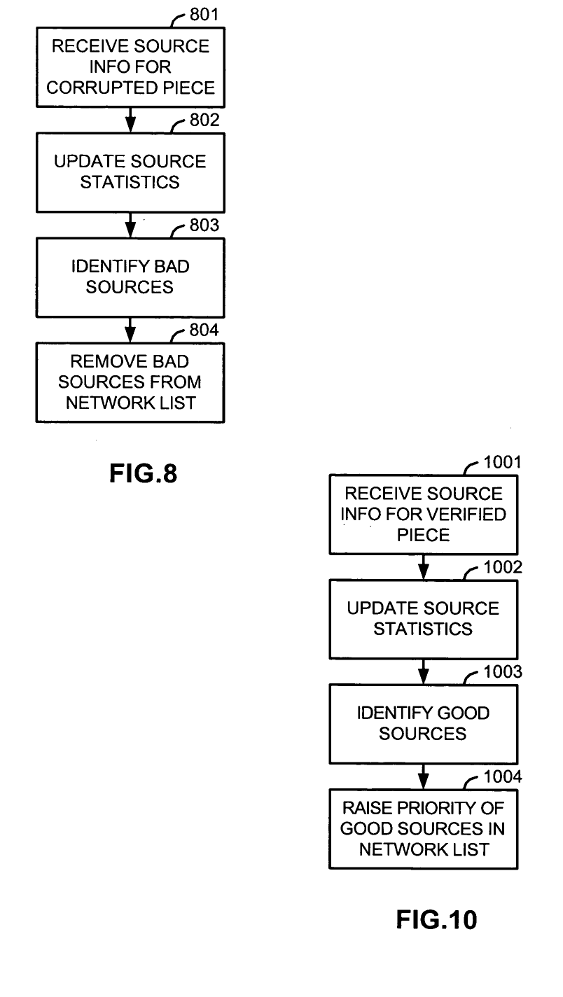

The tracker server then generally performs the functions previously described as being performed by the block requesting client in the alternative method of FIG. 5. Referring to FIG. 8, in 801, the tracker server receives the source information for a corrupted piece from the block requesting client. In 802, the tracker server then updates source statistics that it is keeping track of for each of the sources that provided one or more blocks for the corrupted piece. In 803, the tracker server then analyzes the source statistics to identify bad sources according to predetermined criteria, and in 804, the tracker server removes the identified bad sources (e.g., P2P clients that have been found to provide corrupting data more frequently than an acceptable level) from the network list that it periodically provides to the P2P clients. The P2P clients, including the block requesting client, may then disconnect or refuse connection to any source not included in an updated network list provided by the tracker server.

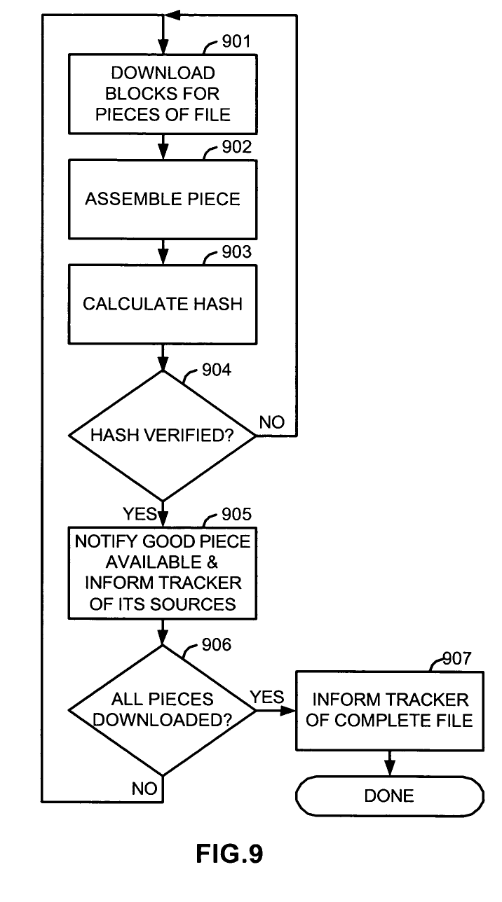

FIGS. 9˜10 illustrate, as examples, flow diagrams for an alternative good source identifying method for deterring corruption of a swarm download in a file sharing network. This method primarily differs from the method described in reference to FIG. 6 in that instead of the block requesting client updating the source statistics and identifying good sources, the block/source information for verified pieces are sent to the tracker server, and the tracker server performs those functions.

Therefore, as in the case of 601-607 in FIG. 6, 901-907 in FIG. 9 are generally conventional tasks performed in the BitTorrent protocol by a block requesting client (such as client 101 or 102 in the example described in reference to FIG. 1) during a swarm download of a content file in a file sharing network. When the hashes for assembled pieces from downloaded blocks are verified in 904, the block requesting client not only notifies the P2P clients and the tracker server of the availability of the good piece, it also sends source information for the blocks of the verified piece to the tracker server.

The tracker server then generally performs the functions previously described as being performed by the block requesting client in the alternative method of FIG. 6. Referring to FIG. 10, in 1001, the tracker server receives the source information for a verified piece from the block requesting client. In 1002, the tracker server then updates source statistics that it is keeping track of for each of the sources that provided one or more blocks for the verified piece. In 1003, the tracker server then analyzes the source statistics to identify good sources according to predetermined criteria, and in 1004, the tracker server raises the priority for downloading and uploading for the identified good sources (e.g., P2P clients that have been found to provide good data more frequently than a minimum threshold level), and provides an indication of such increased priority on the network list that it periodically provides to the P2P clients. The P2P clients, including the block requesting client, may then treat these good sources accordingly in an updated network list provided by the tracker server.

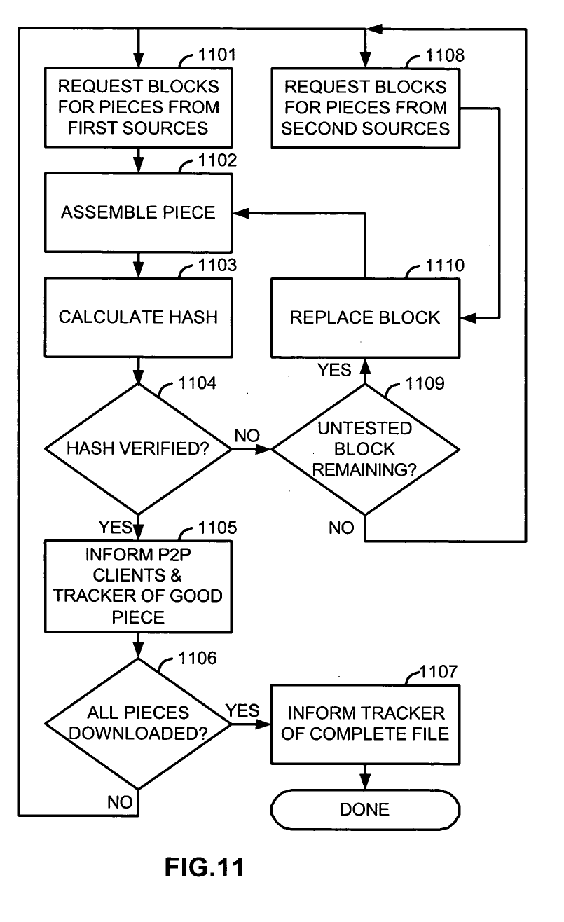

FIG. 11 illustrates, as an example, a flow diagram of a redundant block requesting method for deterring corruption of a swarm download in a file sharing network. This method also identifies bad sources (i.e., sources that provide corrupt data), but does so in a different manner than described in reference to FIGS. 5 and 7. As in other methods, 1101-1107 in this method are generally conventional tasks performed in the BitTorrent protocol by a block requesting client (such as client 101 or 102 in the example described in reference to FIG. 1) during a swarm download of a content file in a file sharing network.

In 1108, however, the block requesting client requests a redundant set of blocks for each piece of the file requested in 1101. In particular, in 1101, the block requesting client requests the blocks for pieces of the file from a first or primary set of sources, and in 1108, it also requests the blocks for the pieces from a second or back-up set of sources. To make sure that such requests are done in a redundant fashion, it is preferable that there be no overlap between the first and second sets of sources (i.e., the two sets have no common members). However, this is not an absolute requirement. There may be some overlap of sources in the two sets as long as corresponding blocks are requested from different sources in 1101 and 1108.

In this method, when the hash for an assembled piece is not verified in 1104, a determination is preferably first made in 1109 whether an untested block is still remaining. An untested block in this case is a block received in response to 1108 that has not gone through the replacement process performed in 1110.

If the determination in 1109 is YES, then the method proceeds to 1110, where the block requesting client replaces one of the blocks in the piece assembled in 1102 with its corresponding, untested block received in response to the block requests in 1108. A hash value for the newly assembled piece is then calculated in 1103, and compared against the known hash value in 1104. If the piece verifies this time, then the block replaced in 1110 was corrupt and its source is identified as a bad source. This time, in 1105, in addition to informing the P2P clients and the tracker server that a good piece is now available for downloading, the block requesting client may also inform the tracker server of the identified bad source so that it can delete that source or client from its network list. If the piece is not verified this time, then the method goes back to 1109 to process another untested block.

If the determination in 1109 is NO, meaning that there are no more untested blocks remaining from those downloaded for the current piece in response to the block requests in 1108, then the method goes back to 1101 and 1108 to request another set of redundant blocks for the bad piece, and loop through 1101-1110 again in an attempt to successfully download the piece.

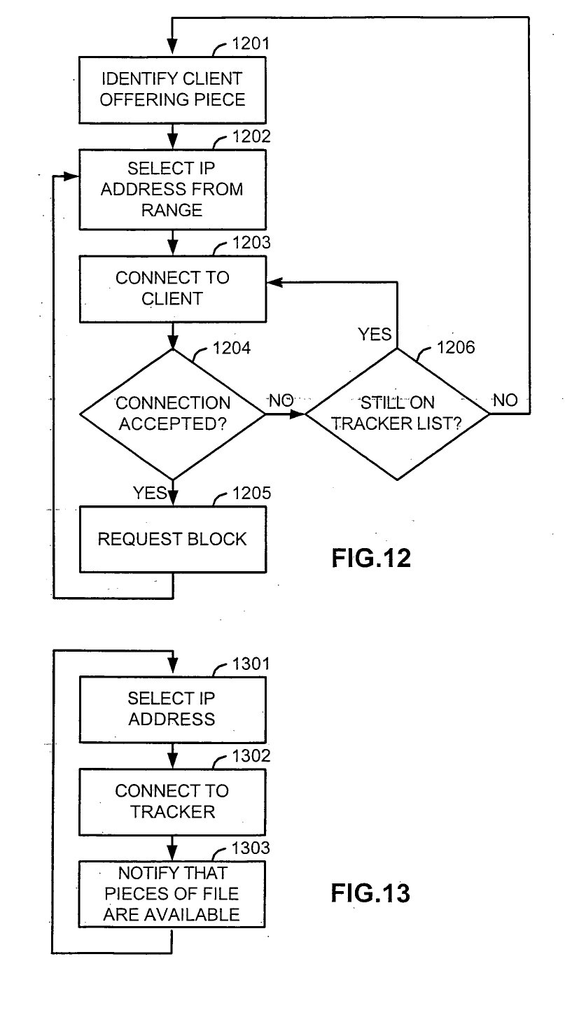

In addition to the method described in reference to FIG. 2, other techniques may also be used alone, or in combination with other methods, to deter unauthorized copying of a protected file in a file sharing network. As one such example, FIG. 12 illustrates a flow diagram an upload choking method for deterring unauthorized copying in a file sharing network. As another example, FIG. 13 illustrates a flow diagram of a source injection method for deterring unauthorized copying in a file sharing network.

In the method of FIG. 12, a source P2P network node is offering a piece of a file, or an entire file, as being available for downloading. The source P2P network node in this case, however, will only upload data to a limited number of destination P2P network nodes at a time. To reduce the number of destination P2P network nodes that can download data from the source P2P network node, the source P2P network node is effectively upload choked by an agent client node making multiple connections to the source P2P network node using different identities such as different IP addresses. The more connections made by the agent client node, the fewer number of destination P2P network nodes that will be able to download data from the source P2P network node.

This technique works particularly well when combined with the method described in reference to FIG. 2 since the priority that is given to connected uploads is related to the speed that the source P2P network node is receiving downloads from another P2P network node. Therefore, if the agent client node is providing a block of corrupted data to a block requesting node at a fast transmission rate, then the block requesting node assigns a higher priority to any upload requests for available pieces made by the agent client node.

Now referring to FIG. 12, in 1201, a source P2P network node (e.g., a client node such as 101 or 102 as described in reference to the example above) is identified by an agent client node (i.e., a node controlled by an entity charged by the owner of a protected file with deterring unauthorized copying of the protected file in a file sharing network, such as client node 103 in the example described above) as offering a piece of the protected file for downloading. It does this, for example, by contacting the tracker server identified in a Torrent file associated with the protected file, and receiving a network list back from the tracker server.

In 1202, the agent client node then selects an IP address from a range of IP addresses pre-assigned to it, and in 1203, it connects to a source P2P network node identified in network list using the selected IP address. If the connection is rejected, then in 1206, the agent client node checks an updated network list from the tracker server to see if the source P2P network node is still on the list. If it is, the agent client node continues to try to connect to it by jumping back to 1203. On the other hand, if it is no longer on the list, that means the source P2P network node is no longer participating in the P2P network, therefore, the agent client node jumps back to 1201 to identify another source P2P network node to perform upload choking upon.

If the connection is accepted, as determined in 1204, then the agent client node requests, in 1205, a block of a piece of the protected file from the source P2P network node. It then keeps looping through 1202-1206 to connect multiple times to the source P2P network node using a different IP address each time and requesting a block of a piece of the protected file each time.

In the method of FIG. 13, a tracker server is coordinating a BitTorrent network that is sharing a content file. The content file in this case is referred to as being a protected file, because it is to be protected by an agent client node against unauthorized copying in a file sharing network. The tracker server provides a network list to each client that connects to it seeking to procure a copy of the protected file. In the BitTorrent protocol, the network list that is provided by the tracker server includes contact information for source nodes that have or are seeking pieces of the content file available for downloading.

To make it difficult for clients to procure copies of the protected file, the agent client node repeatedly notifies the tracker server that it has a full copy, or at least pieces, of the protected file available for downloading, while using a different IP address each time. In reality, however, the agent client node is not willing to download anything but corrupt data if it receives a block request from a network node. Therefore, by injecting many false sources into the P2P network, the agent client node makes it more difficult for P2P network nodes to find legitimate sources for the protected file.

Now referring to FIG. 13, in 1301, the agent client node preferably selects an IP address from a range of IP addresses pre-assigned to it (or optionally, masquerades as being from an IP address that may or may not even exist), and in 1302, it connects to a tracker server which is identified in a Torrent file associated with the protected file and previously procured by the agent client node through, for example, an Internet web search. In 1303, the agent client node then false notifies the tracker server that it has a full copy, or at least pieces, of the protected file available for downloading, so that the tracker server is fooled into adding the currently selected IP address of the agent client node to its network list that it provides to each node connecting to it. The process then loops through 1301-1303 so that multiple false sources for the protected file are now included in the network list provided to P2P client nodes connected to the tracker server, thereby making it more difficult for the P2P client nodes to find a legitimate source for the protected file.

Although the various aspects of the present invention have been described with respect to a preferred embodiment, it will be understood that the invention is entitled to full protection within the full scope of the appended claims.

1. A method for corrupting a swarm download in a file sharing network, comprising: receiving a request from a client in a file sharing network for a portion of a file as part of a swarm download, and providing different content rather than the requested portion so that a calculation based in part on the different content indicates that the swarm download has been corrupted.

2. The method according to claim 1, wherein the calculation is a hash.

3. The method according to claim 2, wherein the file is defined as being divisible into pieces, pre-calculated hash values are available at the client for each of the pieces, the pieces are defined as being divisible into blocks, and the requested portion of the file is a block of one of the pieces of the file.

4. The method according to claim 3, wherein the client performs the calculation by assembling all downloaded blocks of a piece including the different content, calculating a hash value for the assembled piece, and comparing the calculated hash value against the pre-calculated hash value for the piece.

5. The method according to claim 3, further comprising: disconnecting from the client after providing the different content.

6. The method according to claim 5, further comprising: reconnecting to the client during the swarm download after disconnecting from the client, and notifying the client of pieces available for downloading such that the identified pieces do not include blocks for which different content was previously provided.

7. The method according to claim 2, wherein the file is defined as being divisible into segments, a pre-calculated hash value is available at the client for the file, and the requested portion of the file is a segment of the file.

8. The method according to claim 7, wherein the client performs the calculation by assembling all downloaded segments of the file including the different content, calculating a hash value for the assembled file, and comparing the calculated hash value against the pre-calculated hash value for the file.

9. A method for corrupting a swarm download in a network, comprising: (a) connecting to a client participating in a swarm download of a file; (b) indicating to the client that pieces of the file not including any blocks for which corrupting data was previously provided to the client are available for downloading; (c) receiving a request for a block of a piece identified as being available; (d) sending a block of corrupting content to the client in response to the request so that a calculation based in part on the corrupting content indicates that an assembled piece has been corrupted; and (e) disconnecting from the client.

10. The method according to claim 9, further comprising: repeating (a) through (e) until corrupting content for each of the pieces of the file has been sent to the client.

11. The method according to claim 9, further comprising: repeating (a) through (e) until corrupting content for each of the pieces of the file has been sent to the client, or connection to the client is repeatedly refused during the duration of the swarm download.

12. An apparatus for corrupting a swarm download in a file sharing network, comprising an agent client configured to receive a request from a requesting client for a portion of a file as part of a swarm download in a file sharing network, and provide different content rather than the requested portion so that a calculation based in part on the different content indicates that the swarm download has been corrupted.

13. The apparatus according to claim 12, wherein the calculation is a hash.

14. The apparatus according to claim 13, wherein the file is defined as being divisible into pieces, pre-calculated hash values are available for each of the pieces at the requesting client, the pieces are defined as being divisible into blocks, and the requested portion of the file is a block of one of the pieces of the file.

15. The apparatus according to claim 14, wherein the requesting client performs the calculation by assembling all downloaded blocks of a piece including the different content, calculating a hash value for the assembled piece, and comparing the calculated hash value against the pre-calculated hash value for the piece.

16. The apparatus according to claim 14, wherein the agent client is further configured to disconnect from the requesting client after providing the different content.

17. The apparatus according to claim 16, wherein the agent client is further configured to reconnect to the requesting client during the swarm download after disconnecting from the requesting client, and notify the requesting client of pieces available for downloading such that the identified pieces do not include blocks for which different content was previously provided by the agent client to the requesting client.

18. The apparatus according to claim 13, wherein the file is defined as being divisible into segments, a pre-calculated hash value is available at the requesting client for the file, and the requested portion of the file is a segment of the file.

19. The apparatus according to claim 18, wherein the requesting client performs the calculation by assembling all downloaded segments of the file including the different content, calculating a hash value for the assembled file, and comparing the calculated hash value against the pre-calculated hash value for the file.

20. An apparatus for corrupting a swarm download in a network, comprising an agent client configured to: (a) connect to a requesting client participating in a swarm download of a file; (b) indicate to the requesting client that pieces of the file not including any blocks for which corrupting content was previously provided to the client are available for downloading; (c) receive a request for a block of a piece identified as being available; (d) send a block of corrupting content to the requesting client in response to the request so that a calculation based in part on the corrupting content indicates that an assembled piece has been corrupted; and (e) disconnect from the requesting client.

21. The apparatus according to claim 20, wherein the agent client is further configured to: repeat (a) through (e) until corrupting content for each of the pieces of the file have been sent to the requesting client.

22. The apparatus according to claim 20, wherein the agent client is further configured to: repeat (a) through (e) until corrupting content for each of the pieces of the file have been sent to the requesting client, or connection to the requesting client is repeatedly refused during the duration of the swarm download.

23. A method for deterring corruption of a swarm download in a file sharing network, comprising: keeping track of reported available pieces for downloading from each connected client, and disconnecting any such client that reports less available pieces for downloading than reported by that client at a prior time.

24. The method according to claim 23, further comprising: notifying a server with information of any client that reports less available pieces for downloading than reported by that client at a prior time.

25. A method for deterring corruption of a swarm download in a file sharing network, comprising: keeping track of a number of times a client requests connection during a swarm download, and denying such request if the number is greater than or equal to a threshold number.

26. The method according to claim 25, further comprising: notifying a server with information of the client that is denied connection.

27. The method according to claim 25, further comprising: granting such request if the number is less than the threshold number.

28. A method for deterring corruption of a swarm download in a file sharing network, comprising: identifying bad sources in a network by analyzing source statistics updated each time a calculated hash for a piece of a file downloaded as blocks to a client from a plurality of sources fails to match a known hash value for the piece.

29. The method according to claim 28, wherein the updating of the source statistics is performed by the client each time the calculated hash for the piece of the file downloaded as blocks to the client from the plurality of sources fails to match the known hash value for the piece.

30. The method according to claim 29, wherein corresponding source statistics for each of the plurality of sources is incremented by the client each time the calculated hash for the piece of the file downloaded as blocks to the client from the plurality of sources fails to match the known hash value for the piece.

31. The method according to claim 30, wherein the client identifies bad sources by identifying sources having corresponding source statistics that have been incremented more than a threshold number.

32. The method according to claim 31, wherein the threshold number is a function of the source statistics.

33. The method according to claim 28, further comprising: disconnecting any connected ones of the identified bad sources from the client.

34. The method according to claim 28, further comprising: sending information identifying the bad sources to a server involved in managing the network.

35. The method according to claim 34, wherein the server removes references to the bad sources from a network list provided to clients participating in the swarm download.

36. The method according to claim 28, wherein a client notifies a server each time the calculated hash for the piece of the file downloaded as blocks to the client from the plurality of sources fails to match the known hash value for the piece, and provides information identifying the plurality of sources to the server.

37. The method according to claim 36, wherein the updating of the source statistics is performed by the server each time the server is notified by the client that the calculated hash for the piece of the file downloaded as blocks to the client from the plurality of sources fails to match the known hash value for the piece.

38. The method according to claim 37, wherein corresponding source statistics for each of the plurality of sources is incremented by the server each time the calculated hash for the piece of the file downloaded as blocks to the client from the plurality of sources fails to match the known hash value for the piece.

39. The method according to claim 38, wherein the server identifies bad sources by identifying sources having corresponding source statistics that have been incremented more than a threshold number.

40. The method according to claim 39, wherein the threshold number is a function of the source statistics.

41. The method according to claim 39, wherein the server removes references to the bad sources from a network list provided to clients participating in the swarm download.

42. A method for deterring corruption of a swarm download in a file sharing network, comprising: identifying good sources in a network by analyzing source statistics updated each time a calculated hash for a piece of a file downloaded as blocks to a client from a plurality of sources matches a known hash value for the piece.

43. The method according to claim 42, wherein the updating of the source statistics is performed by the client each time the calculated hash for the piece of the file downloaded as blocks to the client from the plurality of sources matches the known hash value for the piece.

44. The method according to claim 43, wherein corresponding source statistics for each of the plurality of sources is incremented by the client each time the calculated hash for the piece of the file downloaded as blocks to the client from the plurality of sources matches the known hash value for the piece.

45. The method according to claim 44, wherein the client identifies good sources by identifying sources having corresponding source statistics that have been incremented more than a threshold number.

46. The method according to claim 44, wherein the threshold number is a function of the source statistics.

47. The method according to claim 42, further comprising: providing a higher priority to connection requests by the identified good sources.

48. The method according to claim 42, further comprising: sending information identifying the good sources to a server involved in managing the network.

49. The method according to claim 42, wherein a client notifies a server each time the calculated hash for the piece of the file downloaded as blocks to the client from the plurality of sources matches the known hash value for the piece, and provides information identifying the plurality of sources to the server.

50. The method according to claim 49, wherein the updating of the source statistics is performed by the server each time the server is notified by the client that the calculated hash for the piece of the file downloaded as blocks to the client from the plurality of sources matches the known hash value for the piece.

51. The method according to claim 50, wherein corresponding source statistics for each of the plurality of sources is incremented by the server each time the calculated hash for the piece of the file downloaded as blocks to the client from the plurality of sources matches the known hash value for the piece.

52. The method according to claim 51, wherein the server identifies good sources by identifying sources having corresponding source statistics that have been incremented more than a threshold number.

53. The method according to claim 52, wherein the threshold number is a function of the source statistics.

54. The method according to claim 52, wherein the server raises a priority level for references to the good sources in a network list provided to clients participating in the swarm download.

55. A method for deterring corruption of a swarm download in a file sharing network, comprising: requesting blocks of a piece of a file in a redundant fashion from alternative sources, assembling the piece from selected blocks, and identifying a bad source providing corrupting content in one of the selected blocks by repeatedly replacing individual of the blocks in the assembled piece with a corresponding block from one of the alternative sources until a calculated hash value for the assembled piece is verified.

56. The method according to claim 55, wherein the blocks are requested in the redundant fashion by requesting each block in the piece from at least two different sources.

57. The method according to claim 55, wherein multiple bad sources are identified by requesting each block in the piece from a sufficient number of different sources so that different combinations of blocks from the different sources serve to identify the multiple bad sources.

58. The method according to claim 55, further comprising: discarding all downloaded blocks if the repeatedly replacing of the individual blocks with corresponding blocks from the alternative sources fails to result in an assembled piece whose calculated hash value is verified, and requesting the blocks of the piece in the same redundant fashion from different alternative sources.

59. The method according to claim 55, further comprising: informing a server that a verified piece is available when the calculated hash value for the assembled piece is verified and sending information of any bad source to the server at that time.

60. A method for deterring unauthorized copying of a protected file in a file sharing network, comprising:
identifying a client offering a piece of a protected file for downloading in a file sharing network, and repeatedly connecting an agent to the client using a different IP address from a range of IP addresses pre-assigned to the agent for each connection, so as to reduce a number of available connections for other clients in the file sharing network to download blocks of the piece from the client.

61. The method according to claim 60, wherein the file sharing network employs a BitTorrent protocol and the identification of the client comprises: causing the agent to contact a tracker server identified in a Torrent file associated with the protected file in order to receive a network list including information of clients participating in a swarm download of the protected file, and connect to individual of the clients on the network list to determine which pieces of the protected file are available from that client for downloading.

62. A method for deterring unauthorized copying of a protected file in a file sharing network, comprising: repeatedly connecting an agent to a server by using a different IP address from a range of IP addresses pre-assigned to the agent for each connection and falsely notifying the server that the agent has the protected file available for downloading each time, so as to increase the difficulty for client nodes relying on information provided by the server to locate legitimate sources for the protected file.

63. The method according to claim 62, wherein metadata associated with the protected file links directly to the server and only indirectly through the server to sources for the protected file.

64. The method according to claim 62, wherein the server is a tracker server, and the tracker server and the client nodes communicate with one another using a BitTorrent protocol.
